(19) United States
(12) Patent Application Publication
(10) Pub. No.: US 2022/0237010 A1
(43) Pub. Date: Jul. 28, 2022

(54) EXECUTING CONTAINERIZED APPLICATIONS USING PARTIALLY DOWNLOADED CONTAINER IMAGE FILES

(71) Applicant: Red Hat, Inc., Raleigh, NC (US)

(72) Inventors: Uri Lublin, Ra'anana (IL); Snir Sheriber, Ra'anana (IL)

(21) Appl. No.: 17/161,070

(22) Filed: Jan. 28, 2021

(51) Int. Cl. G06F 9/455; G06F 16/17

(52) U.S. Cl. CPC G06F 9/45504; G06F 16/1734

(57) ABSTRACT

Executing containerized applications using partially downloaded container image files is disclosed herein. In some examples, a client computing device transmits a request for a container image file for a containerized application to a repository computing device. The container image file includes a plurality of essential files that are required to begin execution of the containerized application, as well as a plurality of non-essential files. The plurality of essential files and the plurality of non-essential files are received by the client computing device from the repository computing device. Subsequent to the client computing device receiving the plurality of essential files, and concurrently with the client computing device receiving the plurality of non-essential files, the client computing device begins execution of the containerized application. In this manner, execution of the containerized application can begin as soon as the files essential for execution have been received by the client computing device.

### BACKGROUND

Container platforms, such as Red Hat® OpenShift®, provide operating-system-level virtualization functionality in the form of isolated user-space instances referred to herein as “containers.” An application to be run within a container (i.e., a “containerized application”) may be encapsulated within a container image file, which includes both the minimum files needed to begin execution of the containerized application (i.e., “essential files”), as well as other files required by the containerized application but not needed to begin execution of the containerized application (i.e., “non-essential files”).

### SUMMARY

The examples disclosed herein relate to executing containerized applications using partially downloaded container image files. In this regard, in some examples, a client computing device (e.g., that provides a container platform) transmits a request for a container image file for a containerized application to a repository computing device (e.g., that provides an image repository in which the container image file is stored). The container image file includes a plurality of essential files that are required to begin execution of the containerized application, as well as a plurality of non-essential files. The plurality of essential files and the plurality of non-essential files are received by the client computing device from the repository computing device. In some examples, the plurality of essential files and the plurality of non-essential files are received in parallel by the client computing device, while some examples may provide that the plurality of essential files are received first by the client computing device. Subsequent to the client computing device receiving the plurality of essential files, and concurrently with the client computing device receiving the plurality of non-essential files, the client computing device begins execution of the containerized application. In some examples, if the executing containerized application attempts to perform a file system access on a non-essential file that is not present on the client computing device, the client computing device may transmit a request for that particular non-essential file to the repository computing device, which then may transmit the non-essential file to the client computing device. The non-essential file that is transmitted may comprise a compressed file (e.g., a copy of a repeatedly requested file among the plurality of non-essential files, as a non-limiting example) that is stored separately from the container image file by the repository computing device. In this manner, execution of the containerized application can begin as soon as the files essential for execution have been received by the client computing device, without the need to wait for the entirety of the container image file to be downloaded.

In another example, a method is provided. The method comprises transmitting, by a processor device of a client computing device, a request for a container image file for a containerized application to a repository computing device, wherein the container image file comprises a plurality of essential files required to begin execution of the containerized application, and a plurality of non-essential files. The method further comprises receiving the plurality of essential files from the repository computing device. The method also comprises receiving the plurality of non-essential files from the repository computing device. The method additionally comprises, subsequent to receiving the plurality of essential files and concurrently with receiving the plurality of non-essential files, executing the containerized application.

In another example, a client computing device is provided. The client computing device comprises a system memory and a processor device coupled to the system memory. The processor device is to transmit a request for a container image file for a containerized application to a repository computing device, wherein the container image file comprises a plurality of essential files required to begin execution of the containerized application, and a plurality of non-essential files. The processor device is further to receive the plurality of essential files from the repository computing device. The processor device is also to receive the plurality of non-essential files from the repository computing device. The processor device is additionally to, subsequent to receiving the plurality of essential files and concurrently with receiving the plurality of non-essential files, execute the containerized application.

In another example, a method is provided. The method comprises receiving, by a processor device of a repository computing device, a request for a container image file from a client computing device, wherein the container image file comprises a plurality of essential files required to begin execution of the containerized application, and a plurality of non-essential files. The method further comprises transmitting the plurality of essential files to the client computing device. The method also comprises transmitting the plurality of non-essential files to the client computing device.

Individuals will appreciate the scope of the disclosure and realize additional aspects thereof after reading the following detailed description of the examples in association with the accompanying drawing figures.

### BRIEF DESCRIPTION OF THE DRAWINGS

The accompanying drawing figures incorporated in and forming a part of this specification illustrate several aspects of the disclosure and, together with the description, serve to explain the principles of the disclosure.

FIG. 1 is a block diagram of a client computing device and a repository computing device in which examples may be practiced;

FIGS. 2A-2D are flowcharts illustrating exemplary operations performed by the client computing device of FIG. 1 for executing containerized applications using partially downloaded container image files;

FIGS. 3A and 3B are flowcharts illustrating exemplary operations performed by the repository computing device of FIG. 1 for providing container image files, according to one example;

FIG. 4 is a simpler block diagram of the client computing device and the repository computing device of FIG. 1 for executing containerized applications using partially downloaded container image files, according to one example;

FIG. 5 is a flowchart of a simplified method for executing containerized applications using partially downloaded container image files by the client computing device of FIG. 4, according to one example;

FIG. 6 is a flowchart of a simplified method for providing container image files by the repository computing device of FIG. 4, according to one example; and

FIG. 7 is a block diagram of a computing device suitable for implementing examples, according to one example.

### DETAILED DESCRIPTION

The examples set forth below represent the information to enable individuals to practice the examples and illustrate the best mode of practicing the examples. Upon reading the following description in light of the accompanying drawing figures, individuals will understand the concepts of the disclosure and will recognize applications of these concepts not particularly addressed herein. It should be understood that these concepts and applications fall within the scope of the disclosure and the accompanying claims.

Any flowcharts discussed herein are necessarily discussed in some sequence for purposes of illustration, but unless otherwise explicitly indicated, the examples are not limited to any particular sequence of steps. The use herein of ordinals in conjunction with an element is solely for distinguishing what might otherwise be similar or identical labels, such as “first request” and “second request,” and does not imply a priority, a type, an importance, or other attribute, unless otherwise stated herein. The term “about” used herein in conjunction with a numeric value means any value that is within a range of ten percent greater than or ten percent less than the numeric value. As used herein and in the claims, the articles “a” and “an” in reference to an element refers to “one or more” of the element unless otherwise explicitly specified. The word “or” as used herein and in the claims is inclusive unless contextually impossible. As an example, the recitation of A or B means A, or B, or both A and B.

As noted above, container platforms, such as Red Hat® OpenShift®, provide operating-system-level virtualization functionality in the form of isolated user-space instances referred to herein as “containers.” Because an application executing within a container can only access the contents of the container and any resources assigned to the container, the container appears, from the perspective of the application, to be a fully functional computing device. The term “containerized application” and derivatives thereof are used herein to refer to such an application to be executed within a container. A containerized application may be encapsulated within a container image file, which includes both the minimum files needed to begin execution of the containerized application (i.e., “essential files”), as well as other files required by the containerized application but not needed to begin execution of the containerized application (i.e., “non-essential files”). The container image file in some examples may comprise a compressed or uncompressed archive file.

Container image files may be hosted within an image repository of a repository computing device, and may be made available for download to client computing devices. Upon downloading the container image file, the client computing device may then employ a local container platform to execute the containerized application within the container image file. However, conventional container platforms require the entire container image file to be downloaded from the repository computing device to the client computing device before execution of the containerized application may begin on the client computing device. In scenarios in which the container image file is very large and/or in which multiple container image files must be downloaded, the time required to download the container image file(s) may be significant.

Accordingly, examples disclosed herein relate to executing containerized applications using partially downloaded container image files. In this regard, in some examples, a client computing device (e.g., that provides a container platform) transmits a request for a container image file for a containerized application to a repository computing device (e.g., that provides an image repository in which the container image file is stored). The container image file includes a plurality of essential files that are required to begin execution of the containerized application, as well as a plurality of non-essential files. The plurality of essential files and the plurality of non-essential files are then received by the client computing device from the repository computing device.

In some examples, the plurality of essential files and the plurality of non-essential files are received in parallel by the client computing device, while some examples may provide that the plurality of essential files are received first by the client computing device. Some examples may provide that the repository computing device transmits the plurality of non-essential files to the client computing device in an order according to time of first access of each non-essential file of the plurality of non-essential files during a previous execution of the containerized application. This may ensure that the non-essential files most likely to be accessed when executing the containerized application are sent first to the client computing device.

Subsequent to the client computing device receiving the plurality of essential files, and concurrently with the client computing device receiving the plurality of non-essential files, the client computing device begins execution of the containerized application. In this manner, execution of the containerized application can begin as soon as the files essential for execution have been received by the client computing device, without the need to wait for the entirety of the container image file to be downloaded. Some examples may provide that the client computing device executes the containerized application after a predetermined delay interval, which may increase the chances that any non-essential files that may be accessed during execution of the containerized application will be received and available for use.

In some examples, the executing containerized application may attempt to perform a file system access on a non-essential file, and the client computing device may detect the file system access and determine that the non-essential file does not exist on the client computing device (i.e., the non-essential file has not yet been received by the client computing device). Some examples may provide that the determination that the non-essential file does not exist on the client computing device may be based on an unsuccessful attempt by the client computing device to perform the file system access. According to some examples, the client computing device may maintain a download complete indicator that indicates whether the download of the plurality of non-essential files is complete. In such examples, the determination that the non-essential file does not exist on the client computing device may be based on the download complete indicator. The client computing devices in some examples may maintain a container file status list that is used to track a download status of each non-essential file of the plurality of non-essential files, and may base the determination that the non-essential file does not exist on the client computing device on the container file status list.

Upon determining that the non-essential file does not exist on the client computing device, the client computing device may transmit a request for the non-essential file to the repository computing device (i.e., while the plurality of non-essential files are being received by the client computing device). The repository computing device may then transmit the requested non-essential file to the client computing device, which may then perform the file system access on the non-essential file. In some examples, the non-essential file that is transmitted may comprise a compressed file, such as a copy of a repeatedly requested file among the plurality of non-essential files, that is stored separately from the container image file by the repository computing device.

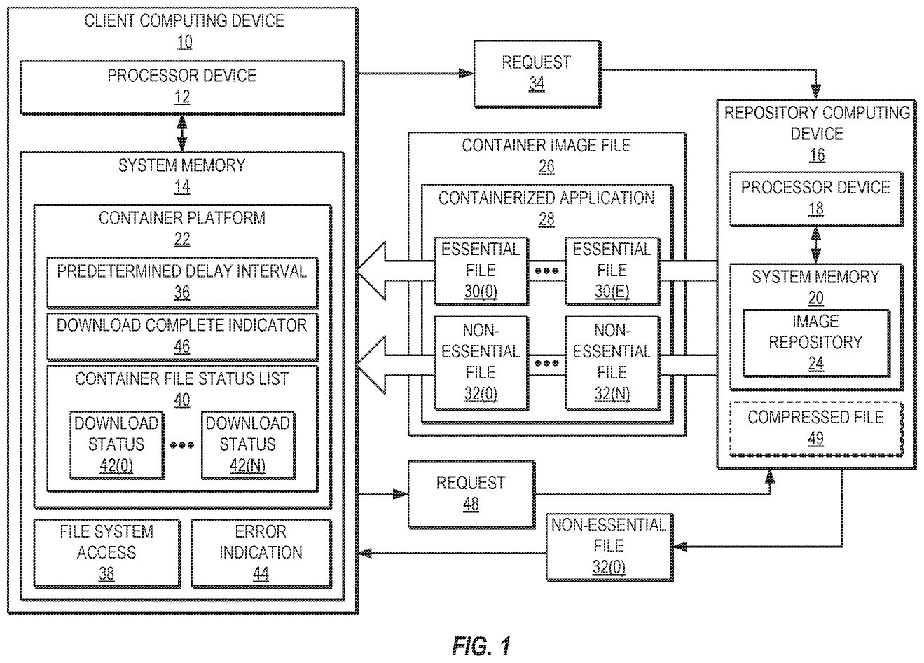

To illustrate a client computing device and a repository computing device on which examples may be practiced, FIG. 1 is provided. In FIG. 1, a client computing device 10 includes a processor device 12 communicatively coupled to a system memory 14. Similarly, a repository computing device 16 includes a processor device 18 communicatively coupled to a system memory 20. The client computing device 10 and the repository computing device 16 of FIG. 1, and the constituent elements thereof, may encompass any one of known digital logic elements, semiconductor circuits, processing cores, and/or memory structures, among other elements, or combinations thereof. Examples described herein are not restricted to any particular arrangement of elements, and it is to be understood that some examples of the client computing device 10 and the repository computing device 16 may include more or fewer elements than illustrated in FIG. 1. For example, the processor device 12 and/or the processor device 18 may further include one or more functional units, instruction caches, unified caches, memory controllers, interconnect buses, and/or additional memory devices, caches, and/or controller circuits, which are omitted from FIG. 1 for the sake of clarity.

In the example of FIG. 1, the processor device 12 of the client computing device 10 executes a container platform 22, which may comprise, e.g., the Red Hat® OpenShift® container platform. The container platform 22 is configured to support the execution of containerized applications using partially downloaded container image files. The processor device 18 of the repository computing device 16 executes an image repository 24, which acts as a distribution hub for container image files such as the container image file 26, and which is configured to support the functionality of the container platform 22 for execution of containerized applications using partially downloaded container image files.

As seen in FIG. 1, the container image file 26 encapsulates a containerized application 28 that comprises a plurality of essential files 30(0)-30(E) and a plurality of non-essential files 32(0)-32(N). The plurality of essential files 30(0)-30(E) correspond to the files required to begin execution of the containerized application 28 by the client computing device 10. In contrast, the plurality of non-essential files 32(0)-32(N) correspond to files that may be accessed in the course of executing the containerized application 28, but that are not required to begin execution of the containerized application 28. In some examples, the plurality of essential files 30(0)-30(E) may be identified as such by a file manifest (not shown) of the container image file 26, or may be identified based on a previous execution of the containerized application 28.

The processor device 12 of the client computing device 10 (e.g., using the container platform 22) transmits a request 34 for the container image file 26 to the repository computing device 16. In response, the processor device 18 of the repository computing device 16 (e.g., using the image repository 24) transmits the plurality of essential files 30(0)-30(E) to the client computing device 10. The processor device 18 of the repository computing device 16 also transmits the plurality of non-essential files 32(0)-32(N) to the client computing device 10. In some examples, the plurality of essential files 30(0)-30(E) and the plurality of non-essential files 32(0)-32(N) are transmitted in parallel by the repository computing device 16 and received by the client computing device 10, while in some examples the plurality of essential files 30(0)-30(E) are transmitted by the repository computing device 16 and received by the client computing device 10 first, before the plurality of non-essential files 32(0)-32(N) are transmitted by the repository computing device 16 and received by the client computing device 10. Some examples may provide that the repository computing device 16 transmits the plurality of non-essential files 32(0)-32(N) to the client computing device 10 in an order according to time of first access of each non-essential file of the plurality of non-essential files 32(0)-32(N) during a previous execution of the containerized application 28. This may ensure that the non-essential files among the plurality of non-essential files 32(0)-32(N) that are most likely to be accessed when executing the containerized application 28 are sent first to the client computing device 10.

Subsequent to receiving the plurality of essential files 30(0)-30(E) and concurrently with receiving the plurality of non-essential files 32(0)-32(N), the client computing device 10 executes the containerized application 28. Thus, execution of the containerized application 28 begins before all of the plurality of non-essential files 32(0)-32(N) have been received by the client computing device 10. Because the client computing device 10 begins execution of the containerized application 28 before all of the plurality of non-essential files 32(0)-32(N) have been received from the repository computing device 16, the client computing device 10 in some examples provides mechanisms to handle file access attempts to a non-essential file of the plurality of non-essential files 32(0)-32(N) that has not yet been received. For instance, some examples may provide that the client computing device 10 may execute the containerized application 28 after a predetermined delay interval 36. This may provide additional time for the plurality of non-essential files 32(0)-32(N) to be received by the client computing device 10, and may increase the chance that a subsequent file access attempt to a non-essential file of the plurality of non-essential files 32(0)-32(N) will be successful.

In some examples, the client computing device 10 may detect a file system access 38 to a non-essential file of the plurality of non-essential files 32(0)-32(N) (such as, e.g., the non-essential file 32(0) of FIG. 1). The client computing device 10 may then determine that the non-essential file 32(0) does not exist on the client computing device 10 (i.e., because it has not yet been received from the repository computing device 16). Some examples may provide that the client computing device 10 bases this determination on a container file status list 40 maintained by the client computing device 10. The container file status list 40 includes a plurality of download statuses 42(0)-42(N) that correspond to the plurality of non-essential files 32(0)-32(N), and that are updated by the client computing device 10 while receiving the plurality of non-essential files 32(0)-32(N). Upon detecting the file system access 38, the client computing device 10 in such examples may use the container file status list 40 to determine that the non-essential file 32(0) does not exist on the client computing device 10.

According to some examples, the client computing device 10 may base the determination that the non-essential file 32(0) does not exist on the client computing device 10 by attempting to perform the file system access 38, and receiving an error indication 44 in response that indicates that the non-essential file 32(0) does not exist on the client computing device 10. Some examples may provide that the determination that the non-essential file 32(0) does not exist on the client computing device 10 is based on a download complete indicator 46 that is maintained by the client computing device 10 to track the status of receiving the plurality of non-essential files 32(0)-32(N). In such examples, the client computing device 10 first sets the download complete indicator 46 to a value of false before sending the request 34 for the container image file 26, and later sets the download complete indicator 46 to a value of true when the plurality of non-essential files 32(0)-32(N) have all been received. The client computing device 10 accordingly may determine that the non-essential file 32(0) does not exist on the client computing device 10 by determining that the download complete indicator 46 is still set to a value of false.

After determining that the non-essential file 32(0) does not exist on the client computing device 10, the client computing device 10 may transmit a request 48 for the non-essential file 32(0) to the repository computing device 16. The repository computing device 16 may then transmit the requested non-essential file 32(0) to the client computing device 10, which may then perform the file system access 38 on the non-essential file 32(0). In some examples, the repository computing device 16 may store a non-essential file, such as the non-essential file 32(0), as a compressed file 49 separate from the container image file 26. The compressed file 49 according to some examples may be a repeatedly requested file among the non-essential files 32(0)-32(N) (i.e., a non-essential file that was requested multiple times during one or more previous executions of the containerized application 28). The compressed file 49 may be stored, e.g., on a persistent storage medium such as a hard drive, or may be stored in the system memory 20. In such examples, the repository computing device 16 may transmit the requested non-essential file 32(0) to the client computing device 10 by transmitting the compressed file 49. In this manner, non-essential files among the non-essential files 32(0)-32(N) that tended to be requested multiples times during previous executions of the containerized application 28, and thus are more likely to be requested in subsequent executions of the containerized application 28, may be more quickly downloaded on request by the client computing device 10.

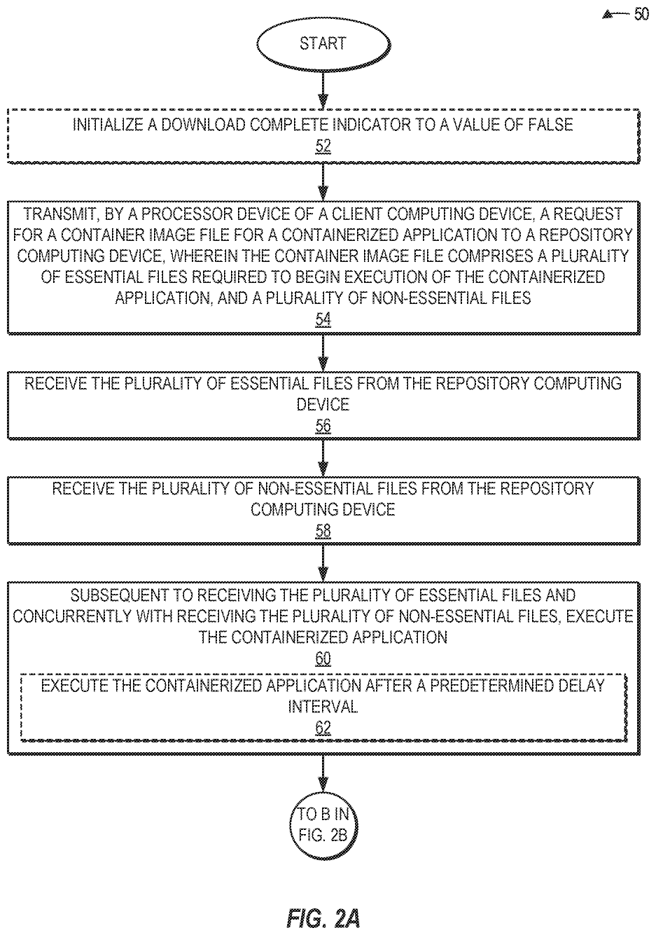

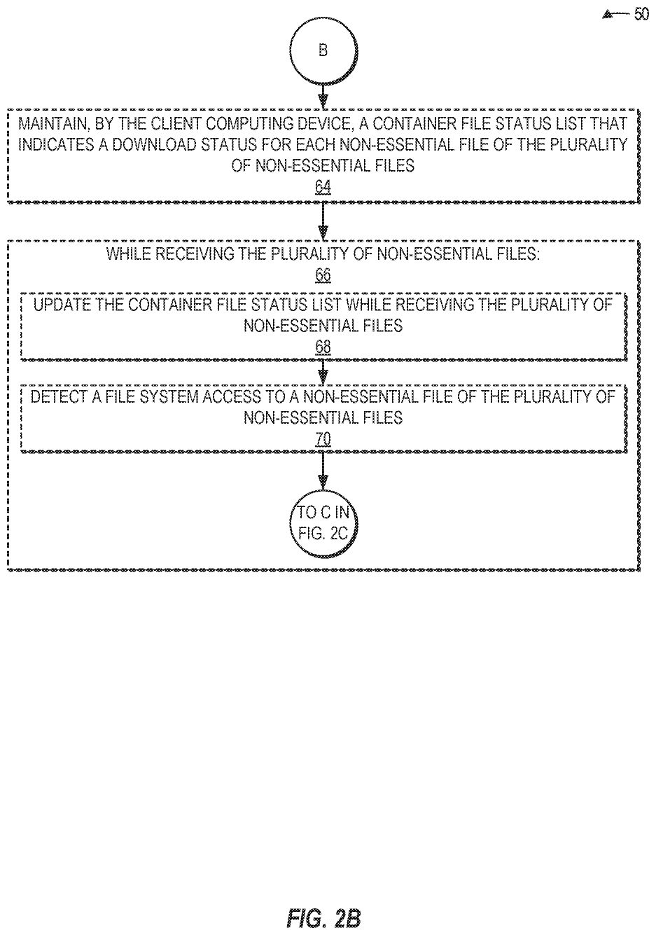

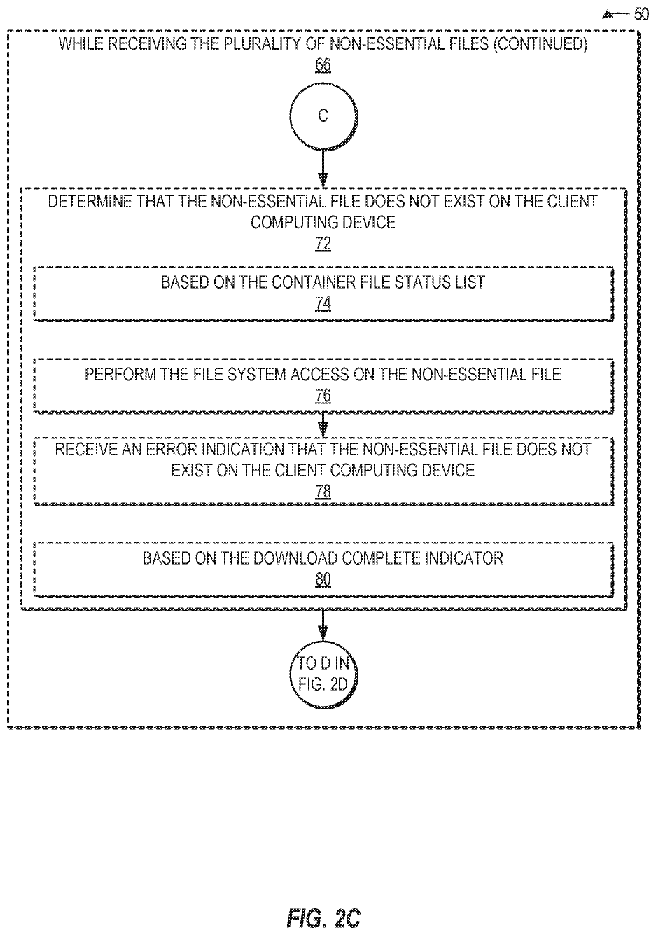

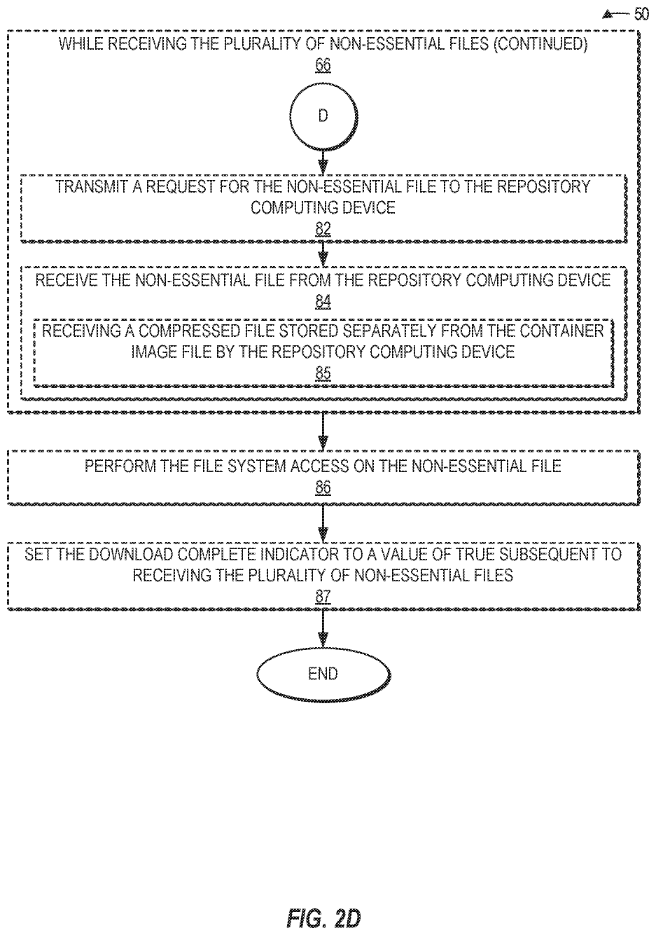

To illustrate exemplary operations performed by the client computing device 10 of FIG. 1 for executing containerized applications using partially downloaded container image files, FIGS. 2A-2D provide a flowchart 50. Elements of FIG. 1 are referenced in describing FIGS. 2A-2D for the sake of clarity. Operations in some examples begin in FIG. 2A with the processor device 12 of the client computing device 10 initializing the download complete indicator 46 to a value of false (block 52). The processor device 12 transmits the request 34 for the container image file 26 for the containerized application 28 to the repository computing device 16, wherein the container image file 26 comprises the plurality of essential files 30(0)-30(E) required to begin execution of the containerized application 28, and the plurality of non-essential files 32(0)-32(N) (block 54).

The processor device 12 then receives the plurality of essential files 30(0)-30(E) from the repository computing device 16 (block 56). The processor device 12 also receives the plurality of non-essential files 32(0)-32(N) from the repository computing device 16 (block 58). Subsequent to receiving the plurality of essential files 30(0)-30(E) and concurrently with receiving the plurality of non-essential files 32(0)-32(N), the processor device 12 executes the containerized application 28 (block 60). In some examples, the operations of block 60 for executing the containerized application 28 comprise executing the containerized application 28 after the predetermined delay interval 36 (block 62). Operations then continue at block 64 in FIG. 2B.

Referring now to FIG. 2B, in some examples, the processor device 12 of the client computing device 10 maintains the container file status list 40 that indicates a download status 42(0)-42(N) for each non-essential file of the plurality of non-essential files 32(0)-32(N) (block 64). The processor device 12 according to some examples may perform operations while receiving the plurality of non-essential files 32(0)-32(N) (block 66). The processor device 12 updates the container file status list 40 while receiving the plurality of non-essential files 32(0)-32(N) (block 68). The processor device 12 detects a file system access 38 to a non-essential file (such as the non-essential file 32(0) of FIG. 1) of the plurality of non-essential files 32(0)-32(N) (block 70). Operations then continue at block 72 of FIG. 2C.

Turning now to FIG. 2C, the processor device 12 determines that the non-essential file 32(0) does not exist on the client computing device 10 (block 72). In some examples, the operations of block 72 for determining that the non-essential file 32(0) does not exist on the client computing device 10 are based on the container file status list 40 (block 74). Some examples may provide that the operations of block 72 for determining that the non-essential file 32(0) does not exist on the client computing device 10 comprise first performing the file system access 38 on the non-essential file 32(0) (block 76). The processor device 12 may then receive an error indication (such as the error indication 44 of FIG. 1) that the non-essential file 32(0) does not exist on the client computing device 10 (block 78). According to some examples, the operations of block 72 for determining that the non-essential file 32(0) does not exist on the client computing device 10 are based on the download complete indicator 46 (block 80). Operations then resume at block 82 of FIG. 2D.

Referring now to FIG. 2D, after determining that the non-essential file 32(0) does not exist on the client computing device 10, the processor device 12 may transmit a request 48 for the non-essential file 32(0) to the repository computing device 16 (block 82). The processor device 12 subsequently receives the non-essential file 32(0) from the repository computing device 16 (block 84). In some examples, the operations of block 84 for receiving the non-essential file 32(0) may comprise receiving a compressed file, such as the compressed file 49 of FIG. 1, that is stored separately from the container image file 26 by the repository computing device 16 (block 85). The processor device 12 then performs the file system access 38 on the non-essential file 32(0) (block 86). The processor device 12 in some examples sets the download complete indicator 46 to a value of true subsequent to receiving the plurality of non-essential files 32(0)-32(N) (block 87).

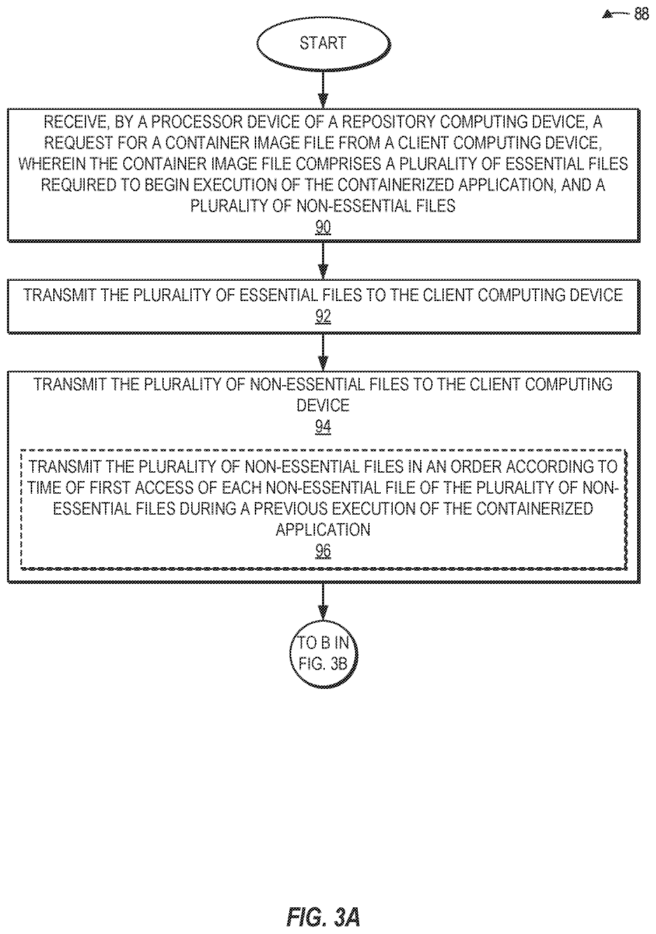

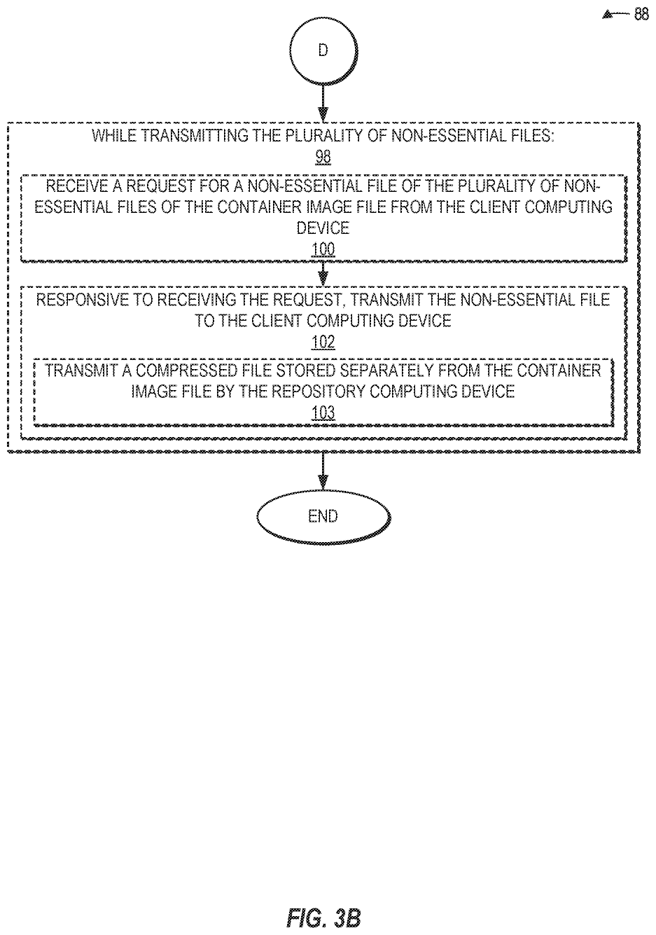

FIGS. 3A and 3B provide a flowchart 88 that illustrates exemplary operations performed by the repository computing device 16 of FIG. 1 for providing container image files, according to one example. For the sake of clarity, elements of FIG. 1 are referenced in describing FIGS. 3A and 3B. Operations in FIG. 3A begin with the processor device 18 of the repository computing device 16 receiving the request 34 for the container image file 26 from the client computing device 10, wherein the container image file 26 comprises the plurality of essential files 30(0)-30(E) required to begin execution of the containerized application 28, and the plurality of non-essential files 32(0)-32(N) (block 90). The processor device 18 transmits the plurality of essential files 30(0)-30(E) of the container image file 26 to the client computing device 10 (block 92). The processor device 18 also transmits the plurality of non-essential files 32(0)-32(N) of the container image file 26 to the client computing device 10 (block 94). In some examples, the operations of block 94 for transmitting the plurality of non-essential files 32(0)-32(N) of the container image file 26 may comprise transmitting the plurality of non-essential files 32(0)-32(N) in an order according to time of first access of each non-essential file of the plurality of non-essential files 32(0)-32(N) during a previous execution of the containerized application 28 (block 96). Operations then continue at block 98 of FIG. 3B.

Turning now to FIG. 3B, the processor device 18 according to some examples may perform operations while transmitting the plurality of non-essential files 32(0)-32(N) (block 98). In particular, the processor device 18 may receive a request (such as the request 48 of FIG. 1) for a non-essential file (such as the non-essential file 32(0) of FIG. 1) of the plurality of non-essential files 32(0)-32(N) of the container image file 26 from the client computing device 10 (block 100). The processor device 18 may then, responsive to receiving the request 48, transmit the non-essential file 32(0) to the client computing device 10 (block 102). Some examples may provide that the operations of block 102 for transmitting the non-essential file 32(0) may comprise transmitting a compressed file, such as the compressed file 49 of FIG. 1, that is stored separately from the container image file 26 by the repository computing device 16 (block 103).

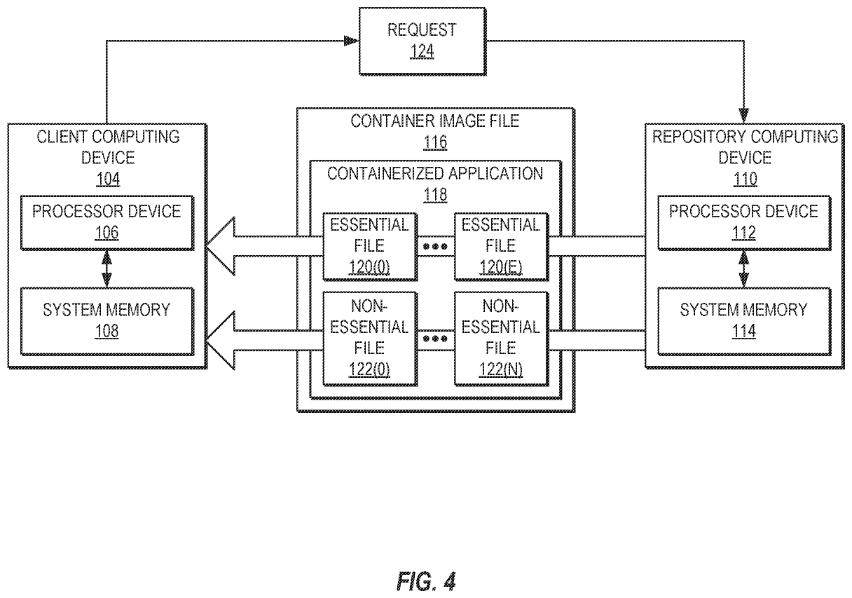

FIG. 4 is a simpler block diagram of the client computing device 10 and the repository computing device 16 of FIG. 1 for executing containerized applications using partially downloaded container image files, according to one example. In FIG. 4, a client computing device 104 includes a processor device 106 communicatively coupled to a system memory 108. Similarly, a repository computing device 110 includes a processor device 112 communicatively coupled to a system memory 114. A container image file 116 provided by the repository computing device 110 encapsulates a containerized application 118 that comprises a plurality of essential files 120(0)-120(E) and a plurality of non-essential files 122(0)-122(N). The plurality of essential files 120(0)-120(E) correspond to the files required to begin execution of the containerized application 118 by the client computing device 104. In contrast, the plurality of non-essential files 122(0)-122(N) correspond to files that may be accessed in the course of executing the containerized application 118, but that are not required to begin execution of the containerized application 118.

The processor device 106 of the client computing device 104 transmits a request 124 for the container image file 116 to the repository computing device 110. In response, the processor device 112 of the repository computing device 110 transmits the plurality of essential files 120(0)-120(E) to the client computing device 104. The processor device 112 of the repository computing device 110 also transmits the plurality of non-essential files 122(0)-122(N) to the client computing device 104. Subsequent to receiving the plurality of essential files 120(0)-120(E) and concurrently with receiving the plurality of non-essential files 122(0)-122(N), the client computing device 104 executes the containerized application 118. Thus, execution of the containerized application 118 begins before all of the plurality of non-essential files 122(0)-122(N) have been received by the client computing device 104.

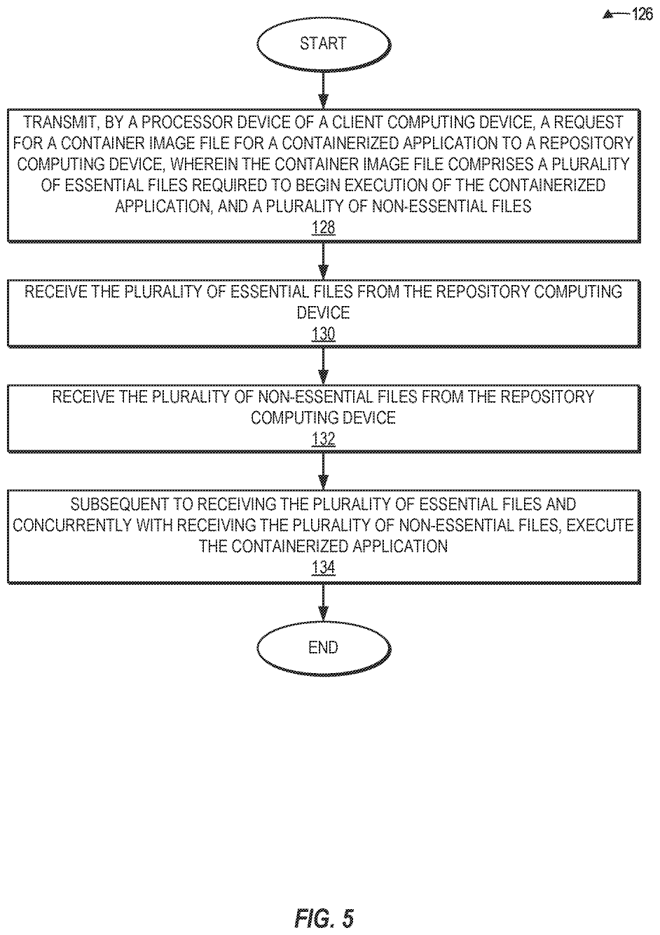

FIG. 5 provides a flowchart 126 illustrating a simplified method for executing containerized applications using partially downloaded container image files using the client computing device 104 of FIG. 4, according to one example. Elements of FIG. 4 are referenced in describing FIG. 5 for the sake of clarity. Operations in FIG. 5 begin with the processor device 106 of the client computing device 104 transmitting the request 124 for the container image file 116 for the containerized application 118 to the repository computing device 110, wherein the container image file 116 comprises the plurality of essential files 120(0)-120(E) required to begin execution of the containerized application 118, and the plurality of non-essential files 122(0)-122(N) (block 128). The processor device 106 then receives the plurality of essential files 120(0)-120(E) from the repository computing device 110 (block 130). The processor device 106 also receives the plurality of non-essential files 122(0)-122(N) from the repository computing device 110 (block 132). Subsequent to receiving the plurality of essential files 120(0)-120(E) and concurrently with receiving the plurality of non-essential files 122(0)-122(N), the processor device 106 executes the containerized application 118 (block 134).

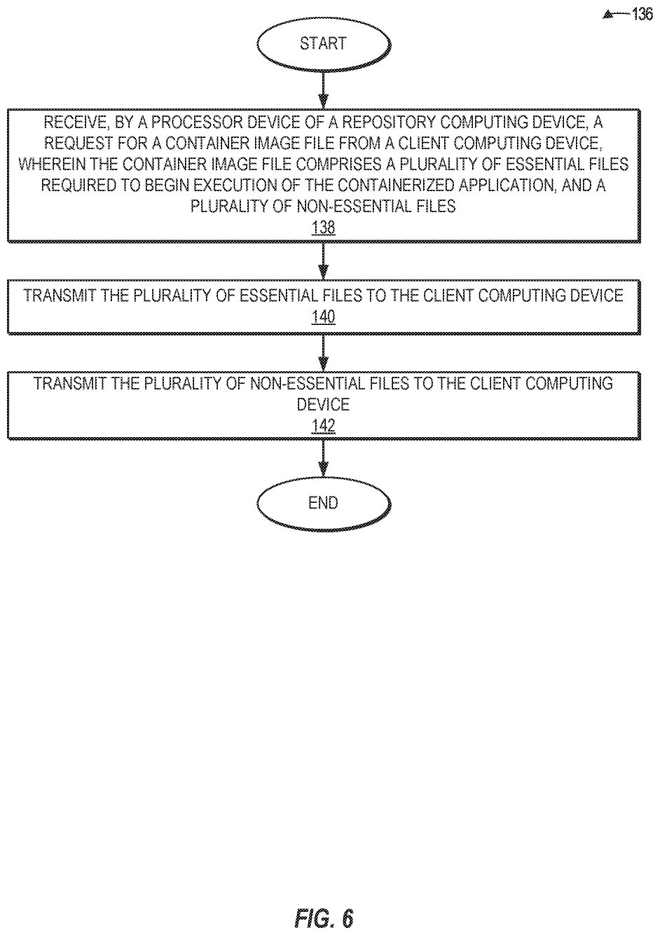

To illustrate a simplified method for executing containerized applications using partially downloaded container image files using the repository computing device 110 of FIG. 4 according to one example, FIG. 6 provides a flowchart 136. For the sake of clarity, elements of FIG. 4 are referenced in describing FIG. 6. Operations in FIG. 6 begin with the processor device 112 of the repository computing device 110 receiving the request 124 for the container image file 116 from the client computing device 104, wherein the container image file 116 comprises the plurality of essential files 120(0)-120(E) required to begin execution of the containerized application 118, and the plurality of non-essential files 122(0)-122(N) (block 138). The processor device 112 then transmits the plurality of essential files 120(0)-120(E) to the client computing device 104 (block 140). The processor device 112 also transmits the plurality of non-essential files 122(0)-122(N) to the client computing device 104 (block 142).

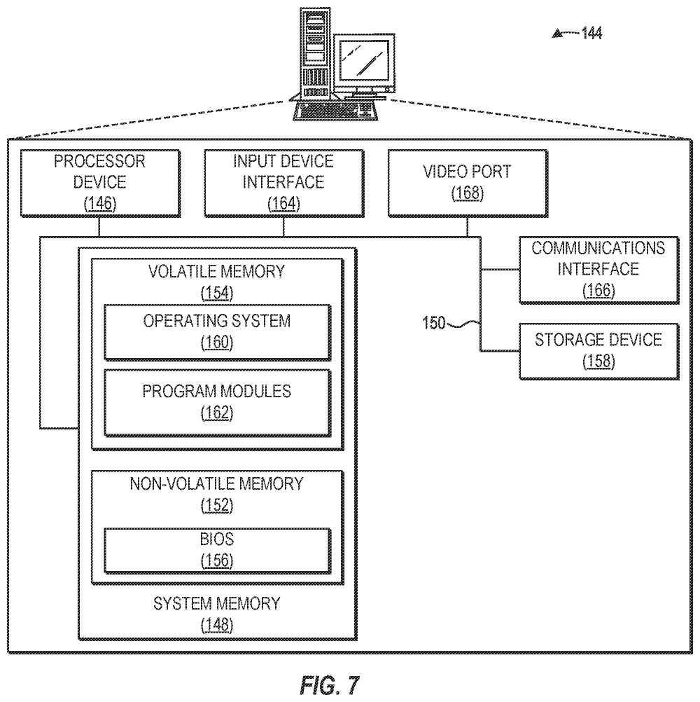

FIG. 7 is a block diagram of a computing device 144, such as the client computing device 10 and the repository computing device 16 of FIG. 1, or the client computing device 104 and the repository computing device 110 of FIG. 4, suitable for implementing examples according to one example. The computing device 144 may comprise any computing or electronic device capable of including firmware, hardware, and/or executing software instructions to implement the functionality described herein, such as a computer server, a desktop computing device, a laptop computing device, a smartphone, a computing tablet, or the like. The computing device 144 includes a processor device 146, a system memory 148, and a system bus 150. The system bus 150 provides an interface for system components including, but not limited to, the system memory 148 and the processor device 146. The processor device 146 can be any commercially available or proprietary processor.

The system bus 150 may be any of several types of bus structures that may further interconnect to a memory bus (with or without a memory controller), a peripheral bus, and/or a local bus using any of a variety of commercially available bus architectures. The system memory 148 may include non-volatile memory 152 (e.g., read-only memory (ROM), erasable programmable ROM (EPROM), electrically EPROM (EEPROM), etc.), and volatile memory 154 (e.g., random access memory (RAM)). A basic input/output system (BIOS) 156 may be stored in the non-volatile memory 152 and can include the basic routines that help to transfer information among elements within the computing device 144. The volatile memory 154 may also include a high-speed RAM, such as static RAM, for caching data.

The computing device 144 may further include or be coupled to a non-transitory computer-readable storage medium such as a storage device 158, which may comprise, for example, an internal or external hard disk drive (HDD) (e.g., enhanced integrated drive electronics (EIDE) or serial advanced technology attachment (SATA)), HDD (e.g., EIDE or SATA) for storage, flash memory, or the like. The storage device 158 and other drives associated with computer-readable media and computer-usable media may provide non-volatile storage of data, data structures, computer-executable instructions, and the like. Although the description of computer-readable media above refers to an HDD, it should be appreciated that other types of media that are readable by a computer, such as Zip disks, magnetic cassettes, flash memory cards, cartridges, and the like, may also be used in the operating environment, and, further, that any such media may contain computer-executable instructions for performing novel methods of the disclosed examples.

A number of modules can be stored in the storage device 158 and in the volatile memory 154, including an operating system 160 and one or more program modules 162 which may implement the functionality described herein in whole or in part. It is to be appreciated that the examples can be implemented with various commercially available operating systems 160 or combinations of operating systems 160. All or a portion of the examples may be implemented as a computer program product stored on a transitory or non-transitory computer-usable or computer-readable storage medium, such as the storage device 158, which includes complex programming instructions, such as complex computer-readable program code, to cause the processor device 146 to carry out the steps described herein. Thus, the computer-readable program code can comprise software instructions for implementing the functionality of the examples described herein when executed on the processor device 146. The processor device 146 may serve as a controller, or control system, for the computing device 144 that is to implement the functionality described herein.

An operator may also be able to enter one or more configuration commands through a keyboard (not illustrated), a pointing device such as a mouse (not illustrated), or a touch-sensitive surface such as a display device (not illustrated). Such input devices may be connected to the processor device 146 through an input device interface 164 that is coupled to the system bus 150 but can be connected by other interfaces, such as a parallel port, an Institute of Electrical and Electronic Engineers (IEEE) 13134 serial port, a Universal Serial Bus (USB) port, an infrared (IR) interface, and the like.

The computing device 144 may also include a communications interface 166 suitable for communicating with a network as appropriate or desired. The computing device 144 may also include a video port 168 to interface with a display device to provide information to a user. Individuals will recognize improvements and modifications to the preferred examples of the disclosure. All such improvements and modifications are considered within the scope of the concepts disclosed herein and the claims that follow.

What is claimed is:

1. A method, comprising:
transmitting, by a processor device of a client computing device, a request for a container image file for a containerized application to a repository computing device, wherein the container image file comprises:
a plurality of essential files required to begin execution of the containerized application; and
a plurality of non-essential files; and
receiving the plurality of essential files from the repository computing device;
receiving the plurality of non-essential files from the repository computing device; and
subsequent to receiving the plurality of essential files and concurrently with receiving the plurality of non-essential files, executing the containerized application.

2. The method of claim 1, further comprising, while receiving the plurality of non-essential files:
detecting a file system access to a non-essential file of the plurality of non-essential files;
determining that the non-essential file does not exist on the client computing device;
transmitting a request for the non-essential file to the repository computing device;
receiving the non-essential file from the repository computing device; and
performing the file system access on the non-essential file.

3. The method of claim 2, further comprising:
maintaining, by the client computing device, a container file status list that indicates a download status for each non-essential file of the plurality of non-essential files; and
updating the container file status list while receiving the plurality of non-essential files;
wherein determining that the non-essential file does not exist on the client computing device is based on the container file status list.

4. The method of claim 2, wherein determining that the non-essential file does not exist on the client computing device comprises:
performing the file system access on the non-essential file; and
receiving an error indication that the non-essential file does not exist on the client computing device.

5. The method of claim 2, further comprising:
initializing a download complete indicator to a value of false prior to transmitting the request for the container image file for the containerized application; and
setting the download complete indicator to a value of true subsequent to receiving the plurality of non-essential files;
wherein determining that the non-essential file does not exist on the client computing device is based on the download complete indicator.

6. The method of claim 2, wherein receiving the non-essential file comprises receiving a compressed file stored separately from the container image file by the repository computing device.

7. The method of claim 6, wherein the compressed file comprises a repeatedly requested file among the plurality of non-essential files.

8. The method of claim 1, wherein executing the containerized application comprises executing the containerized application after a predetermined delay interval.

9. A client computing device, comprising:
a system memory; and
a processor device communicatively coupled to the system memory, the processor device to:
transmit a request for a container image file for a containerized application to a repository computing device, wherein the container image file comprises:
a plurality of essential files required to begin execution of the containerized application; and
a plurality of non-essential files; and
receive the plurality of essential files from the repository computing device;
receive the plurality of non-essential files from the repository computing device; and
subsequent to receiving the plurality of essential files and concurrently with receiving the plurality of non-essential files, execute the containerized application.

10. The client computing device of claim 9, wherein the processor device is further to, while receiving the plurality of non-essential files:
detect a file system access to a non-essential file of the plurality of non-essential files;
determine that the non-essential file does not exist on the client computing device;
transmit a request for the non-essential file to the repository computing device;
receive the non-essential file from the repository computing device; and
perform the file system access on the non-essential file.

11. The client computing device of claim 10, wherein the processor device is further to:
maintain, by the client computing device, a container file status list that indicates a download status for each non-essential file of the plurality of non-essential files; and
update the container file status list while receiving the plurality of non-essential files;
wherein to determine that the non-essential file does not exist on the client computing device is to determine based on the container file status list.

12. The client computing device of claim 10, wherein to determine that the non-essential file does not exist on the client computing device is to:
perform the file system access on the non-essential file; and
receive an error indication that the non-essential file does not exist on the client computing device.

13. The client computing device of claim 10, wherein the processor device is further to:
initialize a download complete indicator to a value of false prior to transmitting the request for the container image file for the containerized application; and
set the download complete indicator to a value of true subsequent to receiving the plurality of non-essential files;
wherein to determine that the non-essential file does not exist on the client computing device is to determine based on the download complete indicator.

14. The client computing device of claim 10, wherein to receive the non-essential file is to receive a compressed file stored separately from the container image file by the repository computing device.

15. The client computing device of claim 14, wherein the compressed file comprises a repeatedly requested file among the plurality of non-essential files.

16. The client computing device of claim 9, wherein to execute the containerized application is to execute the containerized application after a predetermined delay interval.

17. A method, comprising:
receiving, by a processor device of a repository computing device, a request for a container image file from a client computing device, wherein the container image file comprises:
a plurality of essential files required to begin execution of a containerized application; and
a plurality of non-essential files; and
transmitting the plurality of essential files to the client computing device; and
transmitting the plurality of non-essential files to the client computing device.

18. The method of claim 17, further comprising, while transmitting the plurality of non-essential files:
receiving a request for a non-essential file of the plurality of non-essential files of the container image file from the client computing device; and
responsive to receiving the request, transmitting the non-essential file to the client computing device.

19. The method of claim 18, wherein transmitting the non-essential file comprises transmitting a compressed file stored separately from the container image file by the repository computing device.

20. The method of claim 17, wherein transmitting the plurality of non-essential files comprises transmitting the plurality of non-essential files in an order according to time of first access of each non-essential file of the plurality of non-essential files during a previous execution of the containerized application.
